(19) United States
(12) Patent Application Publication
(10) Pub. No.: US 2020/0320993 A1
(43) Pub. Date: Oct. 8, 2020

(54) DIALOGUE PROCESSING APPARATUS, A VEHICLE HAVING THE SAME, AND A DIALOGUE PROCESSING METHOD

(71) Applicants: HYUNDAI MOTOR COMPANY, Seoul (KR); KIA MOTORS CORPORATION, Seoul (KR)

(72) Inventors: Seona Kim, Seoul (KR); Youngmin Park, Gunpo-si (KR); Jeong-Eom Lee, Yongin-si (KR)

(73) Assignees: HYUNDAI MOTOR COMPANY, Seoul (KR); KIA MOTORS CORPORATION, Seoul (KR)

(21) Appl. No.: 16/673,624

(22) Filed: Nov. 4, 2019

(30) Foreign Application Priority Data
Apr. 2, 2019 (KR) 10-2019-0038360

(51) Int. Cl. G10L 15/22; B60R 16/03; G10L 15/18

(52) U.S. Cl. CPC G10L 15/22; B60R 16/0315; G10L 2015/228; G10L 2015/223; G10L 15/1815

(57) ABSTRACT

A dialogue processing apparatus includes: a voice input unit configured to receive speech of a user; a communication device configured to receive dialogue history information of the user from an external device; an output device configured to output visually or audibly a response corresponding to the speech of the user; and a controller. The controller is configured to: determine a user preference response based on the dialogue history information, when the speech of the user is received; generate a response corresponding to the speech of the user based on the user preference response; and control the output device to output the generated response.

### CROSS-REFERENCE TO RELATED APPLICATION(S)

This application claims the benefit of priority to Korean Patent Application No. 10-2019-0038360 filed on Apr. 2, 2019 in the Korean Intellectual Property Office, the disclosure of which is incorporated herein by reference.

### TECHNICAL FIELD

The present disclosure relates to a dialogue processing apparatus configured to provide information or service needed by a user by recognizing the user's intention through dialogue with the user, a vehicle having the same and a dialogue processing method.

### BACKGROUND

A dialogue processing apparatus is an apparatus that performs a dialogue with a user. The dialogue processing apparatus may recognize the user's speech, recognize the user's intention through a speech recognition result, and output a response for providing the user with necessary information or service.

On the other hand, when outputting a response in order to conduct a dialogue with the user, the conventional dialogue processing apparatus has a limitation when outputting the response using a predetermined vocabulary and tone based on stored data. Since actual human-to-human dialogue is performed using various vocabulary and tone of speech depending on the situation of a human speaker or user and the emotion or preference of the human speaker, a technique for generating and outputting a dialogue response reflecting the emotion or preference of the user is required.

### SUMMARY

Embodiments of the present disclosure provide a dialogue processing apparatus capable of receiving speech of a user and outputting a response corresponding to the speech of the user, a vehicle having the same and a dialogue processing method.

Additional aspects of the disclosure are set forth in part in the description which follows and, in part, can be understood from the description, or may be learned by practice of the disclosure.

In accordance with one aspect of the present disclosure, a dialogue processing apparatus comprises: a voice input unit configured to receive a speech of a user; a communication device configured to receive dialogue history information of the user from an external device; an output device configured to output visually or audibly a response corresponding to the speech of the user; and a controller. The controller is configured to: determine a user preference response based on the dialogue history information; when the speech of the user is received; generate a response corresponding to the speech of the user based on the user preference response; and control the output device to output the generated response.

The controller may determine an utterance of the user, a response of a dialogue partner corresponding to the utterance of the user, and feedback of the user corresponding to the response of the dialogue partner based on the dialogue history information. The controller may determine the user preference response based on the feedback of the user.

When a predetermined condition regarding the feedback of the user is satisfied, the controller may determine the response of the dialogue partner corresponding to the feedback of the user as the user preference response.

When a predetermined keyword is included in the feedback of the user, the controller may determine the response of the dialogue partner corresponding to the feedback of the user as the user preference response.

The controller may extract a keyword included in the feedback of the user. When similarity between the extracted keyword and pre-stored positive keyword information is equal to or greater than a predetermined threshold, the controller may determine the response of the dialogue partner corresponding to the feedback of the user as the user preference response.

The controller may extract an emoticon, or an icon included in the feedback content of the user. When a type of the extracted emoticon or icon is a predetermined type, the controller may determine the response of the dialogue partner corresponding to the feedback of the user as the user preference response.

When the feedback of the user to the response of the dialogue partner is performed within a predetermined response time, the controller may determine the response of the dialogue partner corresponding to the feedback of the user as the user preference response.

The controller may determine an emotion of the user based on the feedback of the user. When the emotion of the user is a predetermined kind of emotion, the controller may determine the response of the dialogue partner corresponding to the feedback of the user as the user preference response.

The controller may: determine a user preference for each response of the dialogue partner based on the user feedback; determine the dialogue partner preferred by the user based on the user preference; and determine a response of the dialogue partner preferred by the user, as the user preference response.

The controller may: determine a contact frequency for each of the dialogue partners based on the dialogue history information; apply a weight to the user preference based on the contact frequency; and determine the user preference response based on the weighted user preference.

The dialogue processing apparatus may further comprise a storage configured to store the determined user preference response. The controller may: generate a voice recognition result by recognizing the speech of the user; determine an intention of the user based on the voice recognition result; and control the storage to store the user preference response for each intention of the user.

In accordance with another aspect of the present disclosure, a dialogue processing method of a dialogue processing apparatus comprises a voice input unit configured to receive a speech of a user, and an output device configured to output visually or audibly a response corresponding to the speech of the user. The dialogue processing method comprises: receiving dialogue history information of the user from an external device; determining a user preference response based on the dialogue history information; storing the determined user preference response; generating a response corresponding to the speech of the user based on the user preference response when the speech of the user is received; and outputting the generated response.

The determining of the user preference response based on the dialogue history information may comprise: determining an utterance of the user, a response of a dialogue partner corresponding to the utterance of the user, and feedback of the user corresponding to the response of the dialogue partner based on the dialogue history information; and determining the user preference response based on the feedback of the user.

The determining of the user preference response based on the feedback of the user may comprise, when a predetermined condition regarding the feedback of the user is satisfied, determining the response of the dialogue partner corresponding to the feedback of the user, as the user preference response.

The determining of the user preference response based on the feedback of the user may comprise, when a predetermined keyword, a predetermined type of emoticon, or a predetermined type of icon is included in the feedback of the user, determining the response of the dialogue partner corresponding to the feedback of the user, as the user preference response.

The determining of the user preference response based on the feedback of the user may comprise, when the feedback of the user to the response of the dialogue partner is performed within a predetermined response time, determining the response of the dialogue partner corresponding to the feedback of the user, as the user preference response.

The determining of the user preference response based on the feedback of the user may comprise: determining an emotion of the user based on the feedback of the user; and when the emotion of the user is a predetermined kind of emotion, determining the response of the dialogue partner corresponding to the feedback of the user, as the user preference response.

The determining of the user preference response based on the feedback of the user may comprise: determining a user preference for each response of the dialogue partner based on the user feedback; determining the dialogue partner preferred by the user based on the user preference; and determining a response of the dialogue partner preferred by the user, as the user preference response.

The determining of the user preference response based on the feedback of the user may comprise: determining a contact frequency for each of the dialogue partners based on the dialogue history information; applying a weight to the user preference based on the contact frequency; and determining the user preference response based on the weighted user preference.

In accordance with another aspect of the present disclosure, a vehicle comprising: a voice input unit configured to receive a speech of a user; a communication device configured to receive dialogue history information of the user from an external device; an output device configured to output visually or audibly a response corresponding to the speech of the user; and a controller. The controller is configured to: determine a user preference response based on the dialogue history information; when the speech of the user is received, generate a response corresponding to the speech of the user based on the user preference response; and control the output device to output the generated response.

The controller may be configured to determine an utterance of the user, a response of a dialogue partner corresponding to the utterance of the user, and feedback of the user corresponding to the response of the dialogue partner, based on the dialogue history information. The controller may be further configured to determine the user preference response based on the feedback of the user.

### BRIEF DESCRIPTION OF THE DRAWINGS

FIG. 1A is a control block diagram of a dialogue processing apparatus according to an embodiment of the disclosure.

FIG. 1B is a diagram for a dialogue processing apparatus disposed in a vehicle according to an embodiment of the disclosure.

FIG. 2A is a diagram for describing an operation of determining a user preference response by a dialogue processing apparatus according to an embodiment of the disclosure.

FIG. 2B is a diagram for describing an operation of determining a user preference response by a dialogue processing apparatus according to an embodiment of the disclosure.

FIG. 3 is a diagram illustrating an example of a user preference response acquired by a dialogue processing apparatus according to an embodiment of the disclosure.

FIG. 4 is a flowchart illustrating a dialogue processing method according to an embodiment of the disclosure.

FIG. 5 is a flowchart illustrating a dialogue processing method according to an embodiment of the disclosure.

### DETAILED DESCRIPTION

Throughout this document, the same reference numerals and symbols are used to designate the same or like components. In the following description of the present disclosure, detailed descriptions of known functions and configurations incorporated herein have been omitted when the subject matter of the present disclosure may be rendered rather unclear. The terms as used throughout the specification, such as “˜ part,” “˜ module,” “˜ member,” “˜ block,” etc., may be implemented in software and/or hardware, and a plurality of “˜ parts,” “˜ modules,” “˜ members,” or “˜ blocks” may be implemented in a single element, or a single “˜ part,” “˜ module,” “˜ member,” or “˜ block” may include a plurality of elements.

It should be understood herein that, when a portion is referred to as being “connected to” another portion, not only can it be “directly connected to” the other portion, but it can also be “indirectly connected to” the other portion. When the portion is referred to as being indirectly connected to the other portion, the portion may be connected to the other portion via a wireless communications network.

It should be understood that the terms “comprise,” “include,” “have,” and any variations thereof used herein are intended to cover non-exclusive inclusions unless explicitly described to the contrary.

Although the terms “first,” “second,” “A,” “B,” etc. may be used to describe various components, the terms do not limit the corresponding components, but are used only for the purpose of distinguishing one component from another component.

Descriptions of components in the singular form used herein are intended to include descriptions of components in the plural form, unless explicitly described to the contrary.

The reference numerals or symbols in respective stages are only used to distinguish the respective stages from the other stages, and do not necessarily describe an order of the respective stages. The respective stages may be performed in an order different from the described order, unless a specific order is described in the context.

Hereinafter, embodiments of a vehicle and a control method thereof according to an aspect of the present disclosure are described in detail with reference to the accompanying drawings.

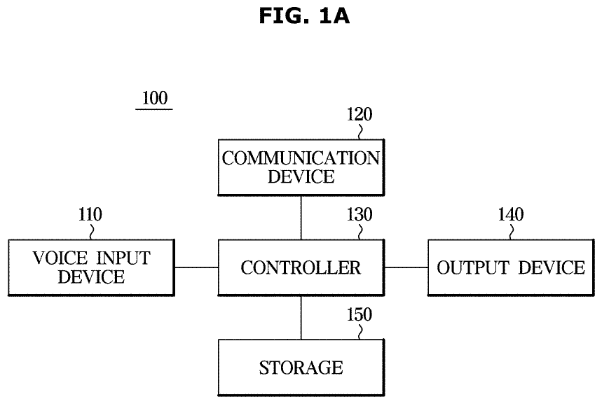

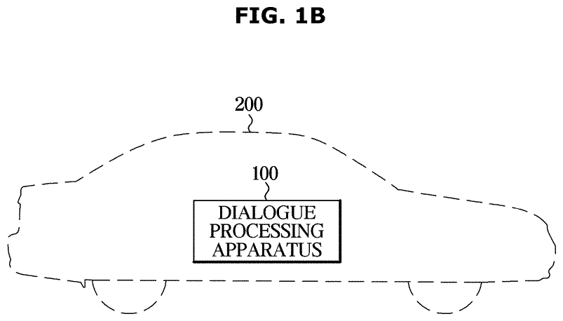

FIG. 1A is a control block diagram of a dialogue processing apparatus according to an embodiment of the disclosure and FIG. 1B is a diagram for a dialogue processing apparatus disposed in a vehicle according to an embodiment of the disclosure.

Referring to FIG. 1A, a dialogue processing apparatus 100 according to an embodiment may include: a voice input device 110 configured to receive speech of a user; a communication device 120 configured to perform communication with an external device; a controller 130 configured to generally control at least one configuration of the dialogue processing apparatus 100; an output device 140; and a storage 150.

The voice input device 110 may receive the speech of the user. The voice input device 110 may include a microphone that receives sound and converts the sound into an electrical signal.

The communication device 120 may receive dialogue history information related to the user from the external device. In this case, the dialogue history information may refer to information for identifying a dialogue of the user performed with an unspecified dialogue partner. The dialogue of the user may include a voice dialogue by a telephone call and a text dialogue using a message service or a messenger.

In addition, the dialogue of the user may include interaction by social network services (SNS) such as Facebook, Twitter, Instagram, and KakaoTalk. For example, by interacting with the SNS, the user may enter a “like” icon on content shared by a specific person while using the Facebook service. In this case, information such as the content and type of a target content to which the user inputs the like icon may be included in the dialogue of the user as interaction history.

The dialogue history information may include not only the above-mentioned dialogue contents but also information on the frequency of dialogue. The dialogue history information may include at least one of telephone information, text information, or SNS information. The telephone information may include at least one of the user's call list or phone book information. The text information may include information on a message sent or received by the user or information on a counterpart who exchanged a message. The SNS information may include interaction information by the aforementioned SNS.

However, the dialogue history information is not limited to the above-described example. The dialogue history information may include all information related to communication performed by the user with an unspecified partner. To this end, the communication device 120 may perform communication with the external device. The external device may include a user terminal or an external server.

The user terminal may be implemented as a computer or a portable terminal capable of connecting to a vehicle 200 (shown in FIG. 1B) through a network. In this embodiment, the computer may include, for example, a notebook computer, a desktop computer, a laptop PC, a tablet PC, a slate PC, and the like, each of which is equipped with a WEB Browser. The portable terminal may be a mobile wireless communication device, and may include: all types of handheld based wireless communication devices, such as a Personal Communication System (PCS), a Global System for Mobile Communications (GSM), Personal Digital Cellular (PDC), a Personal Handyphone System (PHS), a Personal Digital Assistant (PDA), International Mobile Telecommunication (IMT)-2000, Code Division Multiple Access (CDMA)-2000, W-Code Division Multiple Access (W-CDMA), a Wireless Broadband Internet (WiBro) terminal, a Smart Phone, and the like; and wearable devices, such as a watch, a ring, a bracelet, an ankle bracelet, a necklace, glasses, contact lens, or a head-mounted-device (HMD).

Meanwhile, the communication device 120 may include at least one component that enables communication with an external device, for example, at least one of a short-range communication module, a wired communication module, and a wireless communication module.

The short-range communication module may include various short-range communication modules that transmit and receive signals using a wireless communication network in a short range, i.e., a Bluetooth module, an infrared communication module, a radio frequency identification (RFID) communication module, a wireless local access network (WLAN) communication module, an NFC communication module, and a Zigbee communication module.

The wired communication module may include various wired communication modules, i.e., a controller area network (CAN) communication module, a local area network (LAN) module, a wide area network (WAN) module, or a value added network communication (VAN) module, and various cable communication modules, such as a universal serial bus (USB) module, a high definition multimedia interface (HDMI) module, a digital visual interface (DVI) module, a recommended standard-232 (RS-232) module, a power line communication module, or a plain old telephone service (POTS) module.

The wireless communication module may include wireless communication modules supporting various wireless communication methods, i.e., a Wi-Fi module, a wireless broadband (Wibro) module, a global system for mobile communication (GSM) module, a code division multiple access (CDMA) module, a wideband code division multiple access (WCDMA) module, a universal mobile telecommunications system (UMTS) module, a time division multiple access (TDMA) module, a long term evolution (LTE) module, and the like.

The wireless communication module may include a wireless communication interface including an antenna and a transmitter for transmitting signals. In addition, the wireless communication module may further include a signal converting module for converting a digital control signal output from the controller 130 through the wireless communication interface into an analog type wireless signal under the control of the control unit.

The wireless communication module may include the wireless communication interface including the antenna and a receiver for receiving signals. In addition, the wireless communication module may further include the signal converting module for demodulating an analog type wireless signal received through the wireless communication interface into a digital control signal.

The output device 140 may visually or audibly output a response corresponding to a voice of the user. To this end, the output device 140 may include at least one of a speaker for outputting a response corresponding to the voice of the user as a sound or a display for outputting a response corresponding to the voice of the user as an image or text.

When the voice of the user is received, the controller 130 may generate a response corresponding to the voice of the user based on a pre-stored user preference response. The controller 130 may control the output device 140 to output the generated response.

To this end, the controller 130 may determine a user preference response based on the dialogue history information received from the communication device 120 or stored in the storage 150. The controller 130 may store the determined user preference response in the storage 150.

In this case, the user preference response may refer to a dialogue response preferred by the user and may refer to a response of a dialogue partner corresponding to the user's speech as a response of the dialogue partner preferred by the user. A detailed operation for determining the user preference response is described below.

The controller 130 may recognize the user's voice input from the voice input device 110 and convert the voice of the user into text. The controller 130 may apply a natural language understanding algorithm to the spoken text to determine the intention of the user or the dialogue partner. At this time, the intention of the user or the dialogue partner identified by the controller 130 may include a dialogue topic or a call topic identified based on the spoken text.

To this end, the controller 130 may include a voice recognition module and may be implemented as a processor (not shown) that performs an operation for processing an input voice.

On the other hand, if the dialogue between the user and the dialogue partner includes a voice dialogue including a phone call, the controller 130 may recognize the speech of the user and the dialogue partner and convert the speech into text in the form of the dialogue history information. The controller 130 may store the converted text in the storage 150.

In addition, the controller 130 may match at least one of the user preference responses to the intention of the user or the dialogue partner. Alternatively, the controller 130 may control the storage 150 to store the user preference response for each intention of the user or the dialogue partner.

The controller 130 may be implemented as a memory for storing an algorithm for controlling the operation of components in the dialogue processing apparatus 100 or data about a program reproducing the algorithm and a processor (not shown) for performing the above-described operations using the data stored in the memory. In this case, the memory and the processor may each be implemented as separate chips. Alternatively, the memory and the processor may be implemented as a single chip.

The storage 150 may store various information about the dialogue processing apparatus 100 or the vehicle 200 (shown in FIG. 1B).

The storage 150 may store the user preference response acquired by the controller 130 based on the control signal of the controller 130. In addition, the storage 150 may store user information received from the communication device 120. The storage 150 may store various information necessary for recognizing the voice of the user.

To this end, the storage 150 may be implemented as at least one of a non-volatile memory device such as a cache, ROM (Read Only Memory), PROM (Programmable ROM), EPROM (Erasable Programmable ROM), EEPROM (Electrically Erasable Programmable ROM), and a flash memory; a volatile memory device such as RAM (Random Access Memory); and a storage medium such as HDD (hard disk drive) and CD-ROM, but is not limited thereto. The storage 150 may be a memory implemented as a chip separate from the above-described processor in connection with the controller 130. The storage 150 may be implemented as a single chip with the processor.

Referring to FIG. 1B, the dialogue processing apparatus 100 may disposed in the vehicle 200. According to an embodiment, the vehicle 200 may include at least one component of the aforementioned dialogue processing apparatus 100. In this case, the user may be a driver of the vehicle 200, but is not limited thereto and may include a passenger.

At least one component may be added or deleted corresponding to the performance of the components of the dialogue processing apparatus 100 illustrated in FIG. 1A. It should be readily understood by those having ordinary skill in the art that the relative positions of the components may be changed corresponding to the performance or structure of the system.

Each of the components illustrated in FIG. 1A refers to a software component and/or a hardware component such as a Field Programmable Gate Array (FPGA) and an Application Specific Integrated Circuit (ASIC).

Hereinafter, a detailed operation of the controller 130 is described.

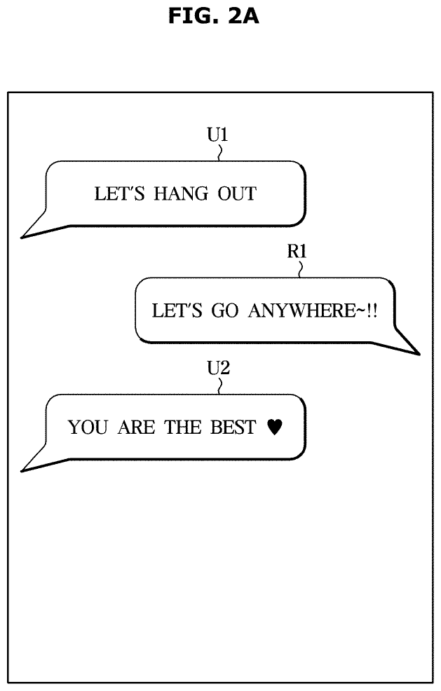

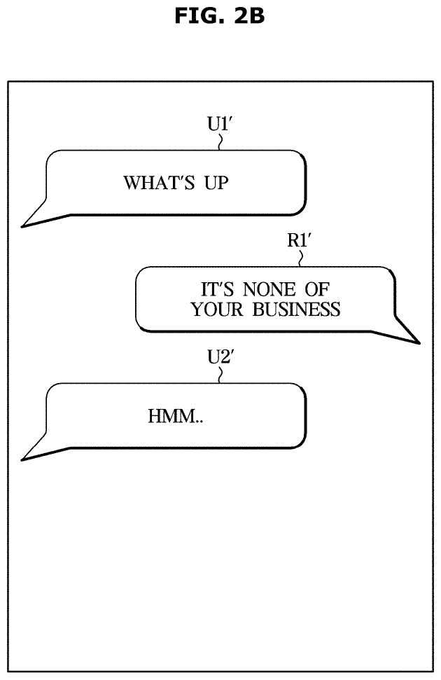

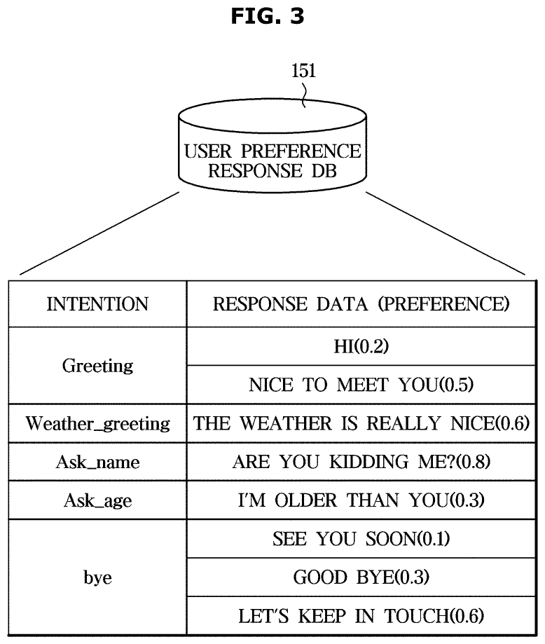

FIG. 2A and FIG. 2B are diagrams for describing an operation of determining a user preference response by a dialogue processing apparatus according to an embodiment of the disclosure. FIG. 3 is a diagram illustrating an example of a user preference response acquired by a dialogue processing apparatus according to an embodiment of the disclosure.

The controller 130 may determine the user preference response based on the dialogue history information. In detail, the controller 130 may determine the user's utterance, the dialogue partners response corresponding to the user's utterance, and the user's feedback on the dialogue partner's response, based on the dialogue history information. The controller 130 may determine the user preference response based on the user's feedback.

For example, as illustrated in FIG. 2A, when the user makes a first utterance U1, “Let's hang out!”, the dialogue partner may make a second utterance R1, “Let's go anywhere!” in response to the user's utterance U1.

In response to the dialogue partner's response R1, if there is dialogue history in which the user has made a third utterance U2, “You are the best ♥” (heart emoticon), the controller 130 may determine the first utterance U1, “Let's hang out!”, as the user's utterance. The controller 130 may further determine the second utterance R1, “Let's go anywhere!”, as the dialogue partner's response corresponding to the user's utterance U1. Also, the controller 130 may determine the third utterance U2, “You are the best ♥”, as the user's feedback corresponding to the dialogue partners response R1. Thereafter, the controller 130 may determine the user preference response based on the user's feedback U2.

If the feedback of the user satisfies a predetermined condition, the controller 130 may determine a response of the dialogue partner corresponding to the feedback of the user, as the user preference response.

In this case, the predetermined condition is a condition for determining whether the user's response is positive and may include at least one of the user's feedback content or a condition for the user's feedback time. The predetermined conditions for identifying the positive response of the user may be predetermined at a stage for design of the apparatus and may be received through the communication device 120.

In detail, when a predetermined keyword is included in the content of the user's feedback, the controller 130 may determine a response of the dialogue partner corresponding to the user's feedback as the user preference response.

To this end, the controller 130 may extract a keyword included in the content of the user's feedback and determine a response of the dialogue partner corresponding to the user's feedback as the user preference response based on the extracted keyword.

The controller 130 may determine the similarity between the keyword included in the user's feedback and the pre-stored positive keyword information. If the similarity between the keyword included in the user's feedback and the pre-stored positive keyword information is equal to or greater than a predetermined similarity, the controller 130 may determine a response of the dialogue partner corresponding to the user's feedback including the corresponding keyword as the user preference response.

In this case, the positive keyword information is a keyword for estimating a positive response of the user and may include, for example, keywords such as ‘best,’ ‘great’ or ‘cool.’ The positive keyword may be received through the communication device 120 and may be stored in the storage 150.

For example, when the dialogue history information described in FIG. 2A is obtained, the controller 130 may extract the keyword of ‘best’ included in the content of the user's feedback U2. When the similarity between the keyword ‘best’ and the predetermined positive keyword is equal to or greater than a predetermined threshold, the controller 130 may determine and store the dialogue partner's response R1 corresponding to the user's feedback U2 as the user preference response.

In addition, the controller 130 may extract an emoticon or icon included in the user's feedback. When a type of the extracted emoticon or icon is a predetermined type, the controller 130 may determine a response of the dialogue partner corresponding to the user's feedback as the user preference response.

When the type of the emoticon or icon is included in the user's feedback or the type of the emoticon or icon in which the user's positive response is estimated is included in the user's feedback, the controller 130 may determine a response of the dialogue partner corresponding to the user's feedback as the user preference response.

For example, when the dialogue history information described in FIG. 2A is obtained, the controller 130 may extract an emoticon ‘♥’ included in the user's feedback U2. When the emoticon ‘♥’ is determined to be a predetermined emoticon type, the controller 130 may determine the dialogue partner's response R1 corresponding to the user's feedback U2 as the user preference response, and the controller stores the user preference response.

In another example, as shown in FIG. 2B, when the dialogue history information including a user's utterance U1′, “What's up?”, a dialogue partner's response R1′ corresponding to the user's utterance U1′, “It's none of your business.”, and a user's feedback U2′, “Hmm . . . ”, is obtained, if there is no keyword, emoticon or icon which can be used for estimating the user's positive response in the user's feedback U2′, the controller may not store the dialogue partner's response Rt.

In addition, when the response time of the user's feedback corresponding to the response of the dialogue partner is less than or equal to the predetermined time, the controller 130 may determine the response of the dialogue partner corresponding to the feedback of the user as the user preference response. In this case, the response time of the user's feedback may refer to a time from the response time of the dialogue partner until the user inputs the feedback.

To this end, the controller 130 may extract the response time of the dialogue partner and the feedback time of the user corresponding thereto from the dialogue history information. The controller 130 may determine the user preference response based on the response time of the extracted user feedback.

In addition, the controller 130 may determine an emotion of the user based on the user's feedback. If the emotion of the user is a predetermined kind of emotion, the controller 130 may determine a response of the dialogue partner corresponding to the user's feedback as the user preference response.

In this case, the controller 130 may determine the emotion of the user based on the feedback content of the user. The controller 130 may determine the user's emotion keyword using an emotion map received or stored in advance through the communication device 120. When the emotion keyword is a predetermined type, the controller 130 may determine the dialogue partner's response corresponding to the user's feedback as the user preference response. In addition, in order to determine the emotion of the user, the controller 130 may utilize height or tone information of the user's voice received through the voice input device 110.

In addition, the controller 130 may determine the user's preference for each response of the dialogue partner based on the user's feedback. The controller 130 may determine the dialogue partner preferred by the user based on the user's preference and determine the user's preferred response as the user's preferred response.

The user's preference for each of the dialogue partner's responses may refer to a degree to which the user's feedback on the dialogue partner's response satisfies the above-mentioned predetermined condition, i.e., the strength of the user's positive response to the dialogue partner's response.

The controller 130 may quantify a degree of satisfying a predetermined condition for the content or the time of the user's feedback described above and determine the quantified degree as a preference.

For example, the controller 130 may quantify the similarity between the keyword included in the content of the user's feedback corresponding the dialogue partner's response and the predetermined keyword. The controller 130 may determine the user's preference based on the similarity. Alternatively, the controller 130 may quantify the similarity between the type of the emoticon or the icon included in the content of the user's feedback corresponding to the dialogue partner's response and the predetermined keyword. The controller 130 may further determine the user's preference based on the similarity.

The controller 130 may determine the dialogue partner that inputs a response whose user's preference is equal to or greater than a predetermined preference as the dialogue partner preferred by the user. The controller 130 may determine a response of the dialogue partner preferred by the user as the user preferred response. In this case, the controller 130 may extract the dialogue history information with the dialogue partner preferred by the user and may store the response of the dialogue partner preferred by the user according to the intention based on the extracted dialogue history information.

The controller 130 may determine a contact frequency for each of the dialogue partners based on the dialogue history information and may apply a weight to the user's preference based on the contact frequency. The controller 130 may determine the user preference response based on the weighted user's preference.

For example, the controller 130 may apply the weight to the user's preference in proportion to the contact frequency. The controller 130 may apply the highest weight to the user's preference regarding the response of the dialogue partner with the highest contact frequency. The controller 130 may determine the dialogue partner's response with the highest user's preference to which the weight is applied as the user preference response.

The user preference response may be stored in the storage 150 and may be stored according to the dialogue intention of the user in the storage 150. In addition, the user's preference corresponding to the dialogue partner's response may also be matched with the response data of the dialogue partner.

For example, as shown in FIG. 3, at least one response data corresponding to at least one intention (i.e., Greeting, Weather_greeting, Ask_name, Ask_age, or bye) is matched with a user preference response database (DB) 151 of the storage 150, respectively. In this case, the at least one response data may be matched with the corresponding preference and stored.

When the voice of the user is input, the controller 130 may generate a response corresponding to the voice of the user based on the user preference response stored in the user preference response DB 151. The controller 130 may identify the user's intention from the voice recognition result of the user's voice and retrieve a response corresponding to the user's intention from the user preference response DB 151.

In this case, the controller 130 may generate a final response corresponding to the voice of the user by using the retrieved user preference response as it is. Alternatively, the controller 130 may generate the final response corresponding to the voice of the user by changing the retrieved user preference response according to a specific situation.

Alternatively, when it is determined that there are a plurality of the user preference responses corresponding to the intention of the user, the controller 130 may generate a response corresponding to the voice of the user based on the preference of the user.

The controller 130 may control the output device 140 to output a response corresponding to the voice of the user. The output device 140 may output the generated response visually or audibly.

Since the user may perform a dialogue using the dialogue response of the dialogue partner that the user prefers, the user may feel like he/she is having a dialogue with the user's favorite dialogue partner. Therefore, the user's convenience and satisfaction can be increased.

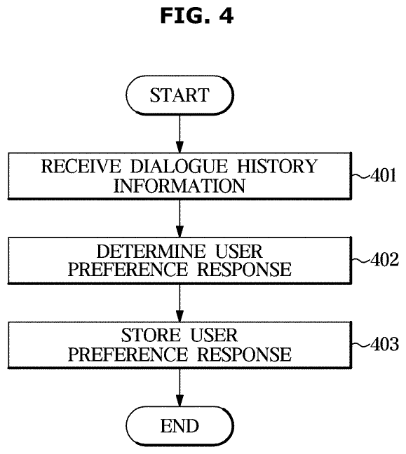

FIG. 4 is a flowchart illustrating a dialogue processing method according to an embodiment of the disclosure.

Referring to FIG. 4, the dialogue processing apparatus 100 according to an embodiment may receive the dialogue history information (401). In this case, the dialogue history information may refer to information for identifying a dialogue of the user performed with the unspecified dialogue partner. The dialogue of the user may include a voice dialogue by a telephone call and a text dialogue using a message service or a messenger. In addition, the dialogue of the user may include interaction by social network services (SNS) such as Facebook, Twitter, Instagram, and KakaoTalk. The detailed description thereof is the same as described above.

The dialogue processing apparatus 100 may determine the user preference response based on the received dialogue history information (402). In this case, the user preference response may refer to a dialogue response preferred by the user. The user preference response may also refer to a response of the dialogue partner corresponding to the user's speech as a response of the dialogue partner preferred by the user.

In detail, the dialogue processing apparatus 100 may determine the user's utterance, the dialogue partner's response corresponding to the user's utterance, and the user's feedback on the dialogue partner's response based on the dialogue history information. The dialogue processing apparatus 100 may determine the user preference response based on the user's feedback.

If the feedback of the user satisfies a predetermined condition, the dialogue processing apparatus 100 may determine a response of the dialogue partner corresponding to the feedback of the user as the user preference response. In this case, the predetermined condition is a condition for determining whether the user's response is positive and may include at least one of the user's feedback content or a condition for the user's feedback time.

In detail, when a predetermined keyword is included in the content of the user's feedback, the dialogue processing apparatus 100 may determine a response of the dialogue partner corresponding to the user's feedback as the user preference response. The dialogue processing apparatus 100 may determine the similarity between the keyword included in the user's feedback and the pre-stored positive keyword information. If the similarity between the keyword included in the user's feedback and the pre-stored positive keyword information is equal to or greater than the predetermined similarity, the dialogue processing apparatus 100 may determine a response of the dialogue partner corresponding to the user's feedback including the corresponding keyword as the user preference response.

In addition, the dialogue processing apparatus 100 may extract an emoticon or icon included in the user's feedback. When a type of the extracted emoticon or icon is a predetermined type, the dialogue processing apparatus 100 may determine a response of the dialogue partner corresponding to the user's feedback as the user preference response.

Also, when the response time of the user's feedback corresponding to the response of the dialogue partner is less than or equal to the predetermined time, the dialogue processing apparatus 100 may determine the response of the dialogue partner corresponding to the feedback of the user as the user preference response. In this case, the response time of the user's feedback may refer to the time from the response time of the dialogue partner until the user inputs the feedback.

Additionally, the dialogue processing apparatus 100 may determine an emotion of the user based on the user's feedback. If the emotion of the user is a predetermined kind of emotion, the dialogue processing apparatus 100 may determine a response of the dialogue partner corresponding to the user's feedback as the user preference response.

Further, the dialogue processing apparatus 100 may determine the user's preference for each response of the dialogue partner based on the user's feedback. The dialogue processing apparatus 100 may determine the dialogue partner preferred by the user based on the user's preference and may determine the user's preferred response as the user's preferred response.

The user's preference for each of the dialogue partner's responses may refer to a degree to which the user's feedback on the dialogue partner's response satisfies the above-mentioned predetermined condition, i.e., the strength of the user's positive response to the dialogue partner's response.

The dialogue processing apparatus 100 may quantify a degree of satisfying a predetermined condition for the content or the time of the user's feedback described above. The dialogue processing apparatus 100 may determine the quantified degree as a preference. The dialogue processing apparatus 100 may determine the dialogue partner that inputs a response whose user's preference is equal to or greater than a predetermined preference as the dialogue partner preferred by the user. The dialogue processing apparatus 100 may determine a response of the dialogue partner preferred by the user as the user preferred response.

In addition, the dialogue processing apparatus 100 may determine a contact frequency for each of the dialogue partners based on the dialogue history information and may apply a weight to the user's preference based on the contact frequency. The dialogue processing apparatus 100 may determine the user preference response based on the weighted user's preference.

The operation of the dialogue processing apparatus 100 for determining the user preference response based on these predetermined conditions is the same as described above.

Once the user preference response is determined, the dialogue processing apparatus 100 may store the user preference response (403). At this time, the dialogue processing apparatus 100 stores the user preference response according to the dialogue intention of the user in the storage 150. In addition, the dialogue processing apparatus 100 may match the user's preference corresponding to the dialogue partner's response with the response data of the dialogue partner.

Additionally, the dialogue processing apparatus 100 may extract the dialogue history information with the dialogue partner preferred by the user. The dialogue processing apparatus 100 may store the response of the dialogue partner preferred by the user according to the intention based on the extracted dialogue history information.

It is possible to identify the user's preferred dialogue response based on the user's dialogue history information and provide the dialogue service according to the user's personal preference by storing the user's preferred dialogue response for each of the user's dialogue intention. Therefore, the user's convenience can be increased.

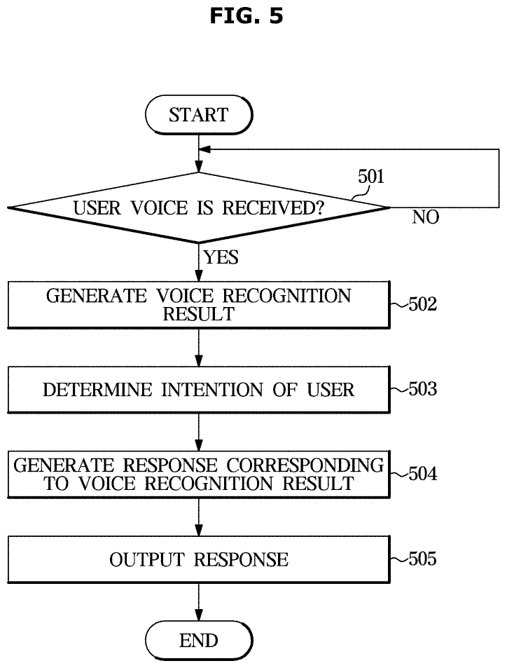

FIG. 5 is a flowchart illustrating a dialogue processing method according to an embodiment of the disclosure.

Referring to FIG. 5, the dialogue processing apparatus 100 according to an embodiment may determine whether the user's voice is received (501). When the user's voice is received (Yes of 501), the dialogue apparatus 100 may generate a voice recognition result of the user's voice (502). In this case, the dialogue processing apparatus 100 may convert the user's voice into a text-type speech as a result of the user's speech recognition and determine the intention of the user or the dialogue partner by applying the natural language understanding algorithm to the user's speech (503).

Thereafter, the dialogue processing apparatus 100 may generate a response corresponding to the voice recognition result of the user based on the stored user preference response (504). The dialogue processing apparatus 100 may retrieve a response corresponding to the user's intention from the user preference response DB 151 and may generate a response based on the response data corresponding to the retrieved user's intention.

In this case, the dialogue processing apparatus 100 may generate the final response corresponding to the voice of the user by using the retrieved user preference response as it is. Alternatively, the dialogue processing apparatus 100 may generate the final response corresponding to the voice of the user by changing the retrieved user preference response according to a specific situation.

Alternatively, when it is determined that there are a plurality of the user preference responses corresponding to the intention of the user, the dialogue processing apparatus 100 may generate a response corresponding to the voice of the user based on the preference of the user.

The dialogue processing apparatus 100 may visually or audibly output a response corresponding to the voice of the user (505).

Since the user may perform a dialogue using the dialogue response of the dialogue partner that the user prefers, the user may feel like he/she is having a dialogue with the user's favorite dialogue partner. Therefore, the user's convenience and satisfaction can be increased.

The disclosed embodiments may be implemented in the form of a recording medium storing instructions executable by a computer. The instructions may be stored in the form of a program code, and when executed by a processor, a program module may be created to perform the operations of the disclosed embodiments. The recording medium may be implemented as a computer-readable recording medium.

The computer-readable recording medium includes all kinds of recording media in which instructions which may be decrypted by a computer are stored. For example, there may be ROM (Read Only Memory), RAM (Random Access Memory), a magnetic tape, a magnetic disk, a flash memory, an optical data storage device, and the like.

As is apparent from the above, according to a dialogue processing device, a vehicle including the same, and a dialogue processing method according to an aspect of the present disclosure, since a dialogue service that satisfies individual preferences is provided, there is an increase in user convenience and satisfaction.

The embodiments disclosed with reference to the accompanying drawings have been described above. It should be understood by those having ordinary skill in the art that various changes in form and details may be made therein without departing from the spirit and scope of the disclosure as defined by the appended claims. The disclosed embodiments are illustrative and should not be construed as limiting.

What is claimed is:

1. A dialogue processing apparatus comprising:
a voice input unit configured to receive a speech of a user;
a communication device configured to receive dialogue history information of the user from an external device;
an output device configured to output visually or audibly a response corresponding to the speech of the user; and
a controller configured to:
determine a user preference response based on the dialogue history information,
when the speech of the user is received, generate a response corresponding to the speech of the user based on the user preference response, and
control the output device to output the generated response.

2. The dialogue processing apparatus of claim 1, wherein the controller is configured to:
determine an utterance of the user, a response of a dialogue partner corresponding to the utterance of the user, and feedback of the user corresponding to the response of the dialogue partner based on the dialogue history information; and
determine the user preference response based on the feedback of the user.

3. The dialogue processing apparatus of claim 2, wherein, when a predetermined condition regarding the feedback of the user is satisfied, the controller is configured to determine the response of the dialogue partner corresponding to the feedback of the user, as the user preference response.

4. The dialogue processing apparatus of claim 3, wherein, when a predetermined keyword is included in the feedback of the user, the controller is configured to determine the response of the dialogue partner corresponding to the feedback of the user, as the user preference response.

5. The dialogue processing apparatus of claim 4, wherein the controller is configured to:
extract a keyword included in the feedback of the user; and
when similarity between the extracted keyword and pre-stored positive keyword information is equal to or greater than a predetermined threshold, determine the response of the dialogue partner corresponding to the feedback of the user, as the user preference response.

6. The dialogue processing apparatus of claim 3, wherein the controller is configured to:
extract an emoticon or an icon included in the feedback content of the user; and
when a type of the extracted emoticon or icon is a predetermined type, determine the response of the dialogue partner corresponding to the feedback of the user, as the user preference response.

7. The dialogue processing apparatus of claim 3, wherein the controller is configured to:
when the feedback of the user to the response of the dialogue partner is performed within a predetermined response time, determine the response of the dialogue partner corresponding to the feedback of the user, as the user preference response.

8. The dialogue processing apparatus of claim 3, wherein the controller is configured to:
determine an emotion of the user based on the feedback of the user; and
when the emotion of the user is a predetermined kind of emotion, determine the response of the dialogue partner corresponding to the feedback of the user, as the user preference response.

9. The dialogue processing apparatus of claim 3, wherein the controller is configured to:
determine a user preference for each response of the dialogue partner based on the user feedback;
determine the dialogue partner preferred by the user based on the user preference; and
determine a response of the dialogue partner preferred by the user, as the user preference response.

10. The dialogue processing apparatus of claim 9, wherein the controller is configured to:
determine a contact frequency for each of the dialogue partners based on the dialogue history information;
apply a weight to the user preference based on the contact frequency; and
determine the user preference response based on the weighted user preference.

11. The dialogue processing apparatus of claim 1, further comprising a storage configured to store the determined user preference response,
wherein the controller is configured to:
generate a voice recognition result by recognizing the speech of the user;
determine an intention of the user based on the voice recognition result; and
control the storage to store the user preference response for each intention of the user.

12. A dialogue processing method of a dialogue processing apparatus comprising a voice input unit configured to receive a speech of a user, and an output device configured to output visually or audibly a response corresponding to the speech of the user, the dialogue processing method comprising the steps of:
receiving dialogue history information of the user from an external device;
determining a user preference response based on the dialogue history information;
storing the determined user preference response;
generating a response corresponding to the speech of the user based on the user preference response when the speech of the user is received; and
outputting the generated response.

13. The dialogue processing method of claim 12, wherein the determining of the user preference response based on the dialogue history information comprises:
determining an utterance of the user, a response of a dialogue partner corresponding to the utterance of the user, and feedback of the user corresponding to the response of the dialogue partner based on the dialogue history information; and
determining the user preference response based on the feedback of the user.

14. The dialogue processing method of claim 13, wherein the determining of the user preference response based on the feedback of the user comprises:
when a predetermined condition regarding the feedback of the user is satisfied, determining the response of the dialogue partner corresponding to the feedback of the user, as the user preference response.

15. The dialogue processing method of claim 14, wherein the determining of the user preference response based on the feedback of the user comprises:
when a predetermined keyword, a predetermined type of emoticon, or a predetermined type of icon is included in the feedback of the user, determining the response of the dialogue partner corresponding to the feedback of the user, as the user preference response.

16. The dialogue processing method of claim 14, wherein the determining of the user preference response based on the feedback of the user comprises:
when the feedback of the user to the response of the dialogue partner is performed within a predetermined response time, determining the response of the dialogue partner corresponding to the feedback of the user, as the user preference response.

17. The dialogue processing method of claim 14, wherein the determining of the user preference response based on the feedback of the user comprises:
determining an emotion of the user based on the feedback of the user; and
when the emotion of the user is a predetermined kind of emotion, determining the response of the dialogue partner corresponding to the feedback of the user, as the user preference response.

18. The dialogue processing method of claim 14, wherein the determining of the user preference response based on the feedback of the user comprises:
determining a user preference for each response of the dialogue partner based on the user feedback;
determining the dialogue partner preferred by the user based on the user preference; and
determining a response of the dialogue partner preferred by the user, as the user preference response.

19. The dialogue processing method of claim 18, wherein the determining of the user preference response based on the feedback of the user comprises:
determining a contact frequency for each of the dialogue partners based on the dialogue history information;
applying a weight to the user preference based on the contact frequency; and
determining the user preference response based on the weighted user preference.

20. A vehicle comprising:
a voice input unit configured to receive a speech of a user;
a communication device configured to receive dialogue history information of the user from an external device;
an output device configured to output visually or audibly a response corresponding to the speech of the user; and
a controller configured to:
determine a user preference response based on the dialogue history information,
when the speech of the user is received, generate a response corresponding to the speech of the user based on the user preference response, and
control the output device to output the generated response.

21. The vehicle of claim 20, wherein the controller is configured to:
determine an utterance of the user, a response of a dialogue partner corresponding to the utterance of the user, and a feedback of the user corresponding to the response of the dialogue partner based on the dialogue history information; and
determine the user preference response based on the feedback of the user.
